(19) United States
(12) Patent Application Publication
(10) Pub. No.: US 2007/0088145 A1
(43) Pub. Date: Apr. 19, 2007

(54) Adhesive useful for film laminating applications

(76) Inventors: Alexander P. Mgaya, Cary, NC (US); Balasubramaniam Ramalingam, Cary, NC (US)

Correspondence Address: HENKEL CORPORATION, THE TRIAD, SUITE 200, 2200 RENAISSANCE BLVD., GULPH MILLS, PA, 19406, US

(21) Appl. No.: 11/253,904

(22) Filed: Oct. 19, 2005

(51) Int. Cl. C08G 18/00

(52) U.S. Cl. 528/44

(57) ABSTRACT

An adhesive that is capable of being curing in at least two stages is prepared by combining at least one isocyanate-functionalized polyurethane prepolymer, at least one hardener, and at least one (meth)acrylate-functionalized compound selected from the group consisting of polyester (meth)acrylates containing hydroxyl functional groups, adducts of epoxy-functionalized poly(meth)acrylic resins and (meth)acrylic acids, polybutadiene (meth)acrylates, and polyoxyalkylene ether mono(meth)acrylates. Such adhesives are particular useful as two part laminating adhesives in the assembly of flexible laminates.

### FIELD OF THE INVENTION

This invention relates to a reactive adhesive capable of being cured in at least two stages, to its production and to its use as a laminating and coating adhesive for multilayer materials.

### BACKGROUND OF THE INVENTION

Adhesives based on polyurethane (PU) prepolymers which contain reactive terminal groups (reactive adhesives) are frequently used for the production of composite materials, particularly multilayer films. The terminal groups are, in particular, terminal groups such as isocyanate groups which are capable of reacting with water or other compounds which contain acidic hydrogen atoms, thereby causing further chain extension and/or crosslinking of the prepolymer. This form of reactivity enables the reactive PU prepolymers to be brought in the required form to the required place in the processable state (generally liquid to highly viscous) and to cure by the addition of water or other compounds containing acidic hydrogen atoms (known in this case as hardeners). With these so-called two part systems, the hardener is generally added immediately before application, so that only a limited processing time is available to the processor after addition of the hardener.

Reactive adhesives suitable for the production of composite materials desirably have a suitable application viscosity, but do not contain any volatile or migratable substances capable of being released into the environment or of migrating through layers of the composite materials. In addition, reactive adhesives of the type in question are expected to meet the requirement that, immediately after application to at least one of the materials to be joined, they have an initial adhesion after the materials have been joined which is sufficient to prevent the composite material from separating into its original constituents or to stop the bonded materials from shifting relative to one another. However, the bond formedis also expected to be sufficiently flexible to withstand the various tensile and elastic stresses to which the multilayer material still at the processing stage is generally exposed without any damage to the adhesive bond or to the bonded material.

A fundamental disadvantage of the conventional solventless reactive adhesives known in the prior art is that the adhesion properties of the reactive adhesive after application are unsatisfactory on account of its low viscosity so that the bond must not be subjected to any load before final curing to ensure that the multilayer material retains the intended shape. However, this means long cure times which often make the production of multilayer materials using such reactive adhesives uneconomical.

One way of avoiding the disadvantages described above is to use a reactive adhesive system curing in several stages in the production of composite materials. The reactive adhesives used are subjected in a first stage to a rapid first curing reaction by irradiation. The strength of the bond after this first curing reaction is supposed to be such that the bonded objects or materials can be handled without difficulty. In a second curing stage, the adhesive continues to cure until it has developed the ultimate strength required.

Such a method is described, for example, in published United States Patent Application No. 2004-0084138, which relates to reactive adhesives which are mixtures of a polyurethane prepolymer having at least one functional group reactive with a composition containing at least one acidic hydrogen atom and at least one compound containing a functional group polymerizable by irradiation. This publication describes certain specific types of substances suitable for use as the latter compound. The reactive adhesive is cured by UV radiation or electron beam radiation and by reaction of free isocyanate groups on the prepolymer with the composition containing at least one acidic hydrogen atom.

However, it would still be desirable to develop a dual cure reactive adhesive with improved properties that would be even more suitable for the production of composite materials, more particularly for the production of film laminates.

### SUMMARY OF THE INVENTION

This invention provides a dual cure adhesive comprising at least one isocyanate-functionalized polyurethane prepolymer, at least one acidic hydrogen-containing hardener, and at least one (meth)acrylate-functionalized compound selected from the group consisting of polyester (meth)acrylates containing hydroxyl functional groups, adducts of epoxy-functionalized poly(meth)acrylic resins and (meth)acrylic acids, polybutadiene (meth)acrylates, and polyoxyalkylene ether mono(meth)acrylates. In one embodiment, the reactive adhesive is a two part adhesive comprising Part A and Part B, wherein Part A comprises the isocyanate-functionalized polyurethane prepolymer and Part B comprises the hardener and wherein either Part A or Part B or both Part A and Part B are additionally comprised of one or more (meth)acrylate-functionalized compounds. The adhesive is particularly useful as a laminating adhesive where, for example, two or more thin films or foils are to be joined to form a flexible laminate suitable for packaging applications and the like.

The dual cure adhesive of the invention can provide several advantages or benefits. It is capable of being partially cured quite rapidly by exposure to ultraviolet to electron beam radiation, thereby permitting near-instantaneous development of bond strength sufficient to secure one substrate to another (e.g., immediate green tack can be attained). At the same time, however, the potlife is sufficiently long that the adhesive can be readily adapted for use in conventional film laminate processes and equipment. The total cure time required is generally reduced as compared to conventional two part laminating adhesives that do not contain any radiation-curable components. Additionally, the adhesive may be formulated to be free of solvent (thereby avoiding emission issues), yet still has a viscosity sufficiently low as to permit easy handling and application. The cured adhesive has good hydrolysis and chemical resistance, as well as bond strength.

### DETAILED DESCRIPTION OF THE INVENTION

A “polymerizable functional group” is understood to be a group which is capable of reacting with another suitable functional group by radical, anionic or cationic polymerization, polycondensation or polyaddition, resulting in an increase in the molecular weight of the molecule carrying that group. In the case of an increase in molecular weight by radical polymerization, the functional group is preferably an olefinically unsaturated double bond. In the case of an increase in molecular weight by polycondensation, the functional group may be, for example, an acid group or an alcohol group. In the case of polyaddition, suitable functional groups are, for example, isocyanate groups or epoxide groups.

By “irradiation” is meant exposure to UV light or to electron beams. A suitable functional group polymerizable by exposure to UV light or to electron beams is, for example, a group with an olefinically unsaturated double bond. According to the invention, preferred olefinically unsaturated double bonds are those present, for example, in derivatives of acrylic acid or styrene. Derivatives of acrylic acid, for example acrylates and methacrylates, are particularly suitable and preferred for the purposes of the invention.

The term “(meth)acrylate” is used herein to mean a functional group, moiety or substituent which may be an acrylate and/or a methacrylate.

The terms “hardening”, “curing” or the like as typically used by the expert are used fairly often hereinafter wherever reference is made to the properties of an adhesive. The “hardening” or “curing” of a composition containing polymerizable compounds is generally based on a polymerization reaction which is accompanied at least by an increase in the molecular weight of the compounds present in the composition. Normally, however, crosslinking reactions also take place at the same time. Accordingly, the terms “hardening”, “curing” or similar terms relate hereinafter to polymerization reactions which may take place in individual components of the composition considered in conjunction with the term, for example the radiation-induced polymerization of a component containing double bonds. The terms also relate to polymerization reactions which may take place among various components of the particular composition under consideration, for example the reaction of a component containing isocyanate groups with a component containing OH groups. The terms also relate to polymerization reactions which may take place between a component of the composition under consideration and a component entering the composition through an outside influence, for example the reaction between isocyanate groups and atmospheric moisture.

A compound containing an acidic hydrogen atom is understood to be a compound which contains an active hydrogen atom attached to an N, O or S atom and determinable by the Zerewitinoff test. Active hydrogen atoms include, for example, the hydrogen atoms of water as well as carboxy, hydroxyl, amino, imino and thiol groups.

The reactive adhesive of the present invention contains in particular a polyurethane prepolymer obtainable by reaction of at least one polyisocyanate and at least one polyol, although other substances may also be present when the reaction is carried out.

The isocyanate-functionalized polyurethane prepolymers suitable for use in accordance with the invention can be produced by reacting at least one monomeric polyisocyanate or a mixture of two or more monomeric polyisocyanates with at least one compound containing at least one (preferably, at least two) acidic hydrogen atom. Suitable monomeric polyisocyanates contain on average two to at most about four isocyanate groups. In a particularly preferred embodiment of the present invention, diisocyanates are used as the monomeric polyisocyanates. Examples of suitable monomeric polyisocyanates are 1,5-naphthylene diisocyanate, 2,2′-, 2,4- and 4,4′-diphenylmethane diisocyanate (MDI), hydrogenated MDI (H₁₂MDI), allophanates of MDI, xylylene diisocyanate (XDI), tetramethyl xylylene diisocyanate (TMXDI), 4,4′-diphenyl dimethylmethane diisocyanate, di- and tetraalkyl diphenylmethane diisocyanate, 4,4′-dibenzyl diisocyanate, 1,3-phenylene diisocyanate, 1,4-phenylene diisocyanate, the isomers of toluene diisocyanate (TDI), 1-methyl-2,4-diisocyanatocyclohexane, 1,6-diisocyanato-2,2,4-trimethyl hexane, 1,6-diisocyanato-2,4,4-trimethyl hexane, 1-isocyanatomethyl-3-isocyanato-1,5,5-trimethyl cyclohexane (IPDI), chlorinated and brominated diisocyanates, phosphorus-containing diisocyanates, 4,4′-diisocyanatophenyl perfluoroethane, tetramethoxybutane-1,4-diisocyanate, butane-1,4-diisocyanate, hexane-1,6-diisocyanate (HDI), dicyclohexylmethane diisocyanate, cyclohexane-1,4-diisocyanate, ethylene diisocyanate, phthalic acid-bis-isocyanatoethyl ester; diisocyanates containing reactive halogen atoms, such as 1-chloromethylphenyl-2,4-diisocyanate, 1-bromomethylphenyl-2,6-diisocyanate or 3,3-bis-chloromethylether-4,4′-di-phenyl diisocyanate. Sulfur-containing polyisocyanates are obtained, for example, by reaction of 2 mol hexamethylene diisocyanate with 1 mol thiodiglycol or dihydroxydihexyl sulfide. Other suitable diisocyanates are, for example, trimethyl hexamethylene diisocyanate, 1,4-diisocyanatobutane, 1,12-diisocyanatododecane and dimer fatty acid diisocyanate. Particularly suitable diisocyanates are tetramethylene, hexamethylene, undecane, dodecamethylene, 2,2,4-trimethylhexane, 2,3,3-trimethylhexamethylene, 1,3-cyclohexane, 1,4-cyclohexane, 1,3- and 1,4-tetramethyl xylene, isophorone, 4,4-dicyclohexanemethane and lysine ester diisocyanates.

Suitable at least trifunctional isocyanates are polyisocyanates formed by trimerization or oligomerization of diisocyanates or by reaction of diisocyanates with polyfunctional compounds containing hydroxyl or amino groups.

Isocyanates suitable for the production of trimers are the diisocyanates mentioned above, the trimerization products of HDI, MDI, TDI and IPDI being particularly preferred.

The polymeric isocyanates formed, for example, as residue in the distillation of diisocyanates are also suitable for use. The polymeric MDI obtainable from the distillation residue in the distillation of MDI is particularly suitable.

In one embodiment of the present invention, IPDI, HDI, MDI and/or TDI are used individually or in admixture as the polyisocyanate which is reacted with the polyol to form the isocyanate-functionalized polyurethane prepolymer.

Polyols are compounds which contain at least two hydroxy (OH) groups per molecule as functional groups. One example of a suitable polyol is a polymeric polyol selected from the group consisting of polyesters, polyethers, polyacetals or polycarbonates with a molecular weight (Mₙ) of at least about 200 g/mol or mixtures of two or more such polymers which contain terminal OH groups.

Polyesters suitable for use in accordance with the invention as polyol for the production of the PU prepolymer may be obtained in known manner by polycondensation of acid and alcohol components, more particularly by polycondensation of a polycarboxylic acid or a mixture of two or more polycarboxylic acids and a polyol or a mixture of two or more polyols.

Polycarboxylic acids suitable in accordance with the present invention for the production of the polyol may be based on an aliphatic, cycloaliphatic, araliphatic, aromatic or heterocyclic parent compound and, besides the at least two carboxylic acid groups, may optionally contain one or more substituents which do not react in the form of a polycondensation reaction, for example, halogen atoms or olefinically unsaturated double bonds. The free carboxylic acids may be replaced by their anhydrides (where they exist) or esters with C₁₋₅ monoalcohols or mixtures of two or more thereof for the polycondensation reaction.

Suitable polycarboxylic acids are, for example, succinic acid, adipic acid, suberic acid, azelaic acid, sebacic acid, glutaric acid, glutaric anhydride, phthalic acid, isophthalic acid, terephthalic acid, trimellitic acid, phthalic anhydride, tetrahydrophthalic anhydride, hexahydrophthalic anhydride, tetrachlorophthalic anhydride, endomethylene tetrahydrophthalic anhydride, glutaric anhydride, maleic acid, maleic anhydride, fumaric acid, dimer fatty acids or trimer fatty acids or mixtures of two or more thereof. Small quantities of monofunctional fatty acids may optionally be present in the reaction mixture.

Various polyols may be used as the diols for producing a polyester or polycarbonate suitable for use as polyol. Examples of such polyols are aliphatic polyols containing 2 to 4 OH groups per molecule. These OH groups may be both primary and secondary OH groups. Suitable aliphatic polyols include, for example, ethylene glycol, propane-1,2-diol, propane-1,3-diol, butane-1,4-diol, butane-1,3-diol, butane-2,3-diol, butene-1,4-diol, butine-1,4-diol, pentane-1,5-diol, and the isomeric pentanediols, pentenediols or pentinediols or mixtures of two or more thereof, hexane-1,6-diol and the isomeric hexanediols, hexenediols or hexinediols or mixtures of two or more thereof, heptane-1,7-diol and the isomeric heptane, heptene or heptinediols, octane-1,8-diol and the isomeric octane, octene or octinediols and higher homologs or isomers of the compounds mentioned, which are obtained in known manner from a step-by-step extension of the hydrocarbon chain by one CH₂ group at a time or by introducing branches into the carbon chain, or mixtures of two or more thereof.

Other suitable polyols are alcohols of relatively high functionality, such as glycerol, trimethylol propane, pentaerythritol, or sugar alcohols, such as sorbitol or glucose, and oligomeric ethers of the substances mentioned either as such or in the form of a mixture of two or more of the compounds mentioned with one another, for example polyglycerol with a degree of polymerization of about 2 to about 4. In the alcohols of relatively high functionality, one or more OH groups may be esterified with monobasic carboxylic acids containing 1 to about 20 carbon atoms, with the proviso that, on average, at least two OH groups remain intact. The alcohols of relatively high functionality mentioned may be used in pure form or, where possible, in the form of the technical mixtures obtainable in the course of their synthesis.

Polyether polyols may also be used as the polyol. Polyether polyols which are to be used as the polyol or for the production of polyesters suitable as the polyol are preferably obtained by reaction of low molecular weight polyols with alkylene oxides. The alkylene oxides preferably contain 2 to about 4 carbon atoms. Suitable polyether polyols are, for example, the reaction products of water, ethylene glycol, propylene glycol, the isomeric butanediols or hexanediols, as mentioned above, or mixtures of two or more thereof with ethylene oxide, propylene oxide or butylene oxide or mixtures of two or more thereof. Other suitable polyether polyols are products of the reaction of polyhydric alcohols, such as glycerol, trimethylol ethane or trimethylol propane, pentaerythritol or sugar alcohols or mixtures of two or more thereof, with the alkylene oxides mentioned to form polyether polyols. Alkoxylation of amines such as ammonia, methyl amine, ethylenediamine, tetra- or hexamethylenediamine, triethanolamine, aniline, phenylenediamine, 2,4- and 2,6-diaminotoluene and polyphenyl polymethylene polyamines may also be practiced to form suitable polyether polyols. Suitable polyether polyols may also be formed by the ring-opening polymerization of cyclic ethers such as tetrahydrofuran. Polyether polyols with a molecular weight (Mₙ) of about 100 to about 3,000 g/mol and preferably in the range from about 200 to about 2,000 g/mol obtainable from the reactions mentioned are particularly suitable. The polyether polyols mentioned may be reacted with the polycarboxylic acids mentioned above in a polycondensation reaction to form the polyesters suitable for use as the polyol.

For example, a polyether polyol and/or polyester polyol with a number average molecular weight of 200 to 4,000 or alternatively from 200 to 2,000 g/mole or a mixture of polyether polyols and/or polyester polyols, which satisfy the limiting criterion of molecular weight, may be used as the polyol.

In another embodiment, a mixture of one or more polyester polyols and one or more polyether polyols is used as the polyol. The various basic polymers may differ, for example, in their molecular weight (Mₙ) or in their chemical structure or in both.

Polyether polyols modified by vinyl polymers are also suitable for use as the polyol. Products such as these can be obtained, for example, by polymerizing styrene or acrylonitrile or a mixture thereof in the presence of polyether polyols.

Polyacetals are also suitable for use as the polyol. Polyacetals are understood to be compounds obtainable by reacting glycols, for example, diethylene glycol or hexanediol, with formaldehyde. Polyacetals suitable for the purposes of the invention may also be obtained by polymerizing cyclic acetals.

Polycarbonates are also suitable or use as the polyol. Polycarbonates may be obtained, for example, by reacting the polyols mentioned above, more particularly diols, such as propylene glycol, butane-1,4-diol or hexane-1,6-diol, diethylene glycol, triethylene glycol or tetraethylene glycol or mixtures of two or more thereof, with diaryl carbonates, for example diphenyl carbonate or phosgene.

Besides the polyols mentioned thus far, other compounds may also be used for the production of the polyurethane prepolymers, for example amines and also water. The following compounds may also be used, among others:
succinic acid di-2-hydroxyethylamide, succinic acid di-N-methyl-(2-hydroxyethyl)-amide, 1,4-di-(2-hydroxymethylmercapto)-2,3,-5,6-tetrachlorobenzene, 2-methylene-1,3-propanediol, 2-methyl-1,3-propanediol, 3-pyrrolidino-1,2-propanediol, 2-methylene-2,4-pentanediol, 3-alkoxy-1,2-propanediol, 2-ethylhexane-1,3-diol, 2,2-dimethyl-1,3-propanediol, 1,5-pentanediol, 2,5-dimethyl-2,5-hexanediol, 3-phenoxy-1,2-propanediol, 3-benzyloxy-1,2-propanediol, 2,3-dimethyl-2,3-butanediol, 3-(4-methoxyphenoxy)-1,2-propanediol and hydroxymethyl benzyl alcohol;
aliphatic, cycloaliphatic and aromatic diamines, such as ethylenediamine, hexamethylenediamine, 1,4-cyclohexylenediamine, piperazine, N-methyl propylenediamine, diaminodiphenyl sulfone, diaminodiphenyl ether, diaminodiphenyl dimethyl methane, 2,4-diamino-6-phenyl triazine, isophoronediamine, dimer fatty acid diamine, diaminodiphenyl methane, aminodiphenylamine or the isomers of phenylenediamine;
carbohydrazides or hydrazides of dicarboxylic acids;
aminoalcohols, such as ethanolamine, propanolamine, butanolamine, N-methyl ethanolamine, N-methyl isopropanolamine, diethanolamine, triethanolamine and higher di- or tri(alkanolamines);
aliphatic, cycloaliphatic, aromatic and heterocyclic mono- and diamino-carboxylic acids, such as glycine, 1- and 2-alanine, 6-aminocaproic acid, 4-aminobutyric acid, the isomeric mono-and diaminobenzoic acids and the isomeric mono-and diaminonaphthoic acids.

The polyol and the monomeric polyisocyanate are preferably used in an equivalents ratio of 1:>2.

If it is desired to avoid the formation of relatively high molecular weight oligomers, the monomeric polyisocyanates are preferably used in a large stoichiometric excess in relation to the polyols. An NCO:OH ratio of 2:1 to 10:1 or 3:1 to 7:1 may be used, for example.

The reaction may be carried out, for example, in the presence of solvents. Basically, suitable solvents are any of the solvents typically used in polyurethane chemistry, more particularly esters, ketones, halogenated hydrocarbons, alkanes, alkenes and aromatic hydrocarbons. Examples of such solvents are methylene chloride, trichloroethylene, toluene, xylene, butyl acetate, amyl acetate, isobutyl acetate, methyl isobutyl ketone, methoxybutyl acetate, cyclohexane, cyclohexanone, dichlorobenzene, diethyl ketone, diisobutyl ketone, dioxane, ethyl acetate, ethylene glycol monobutyl ether acetate, ethylene glycol monoethyl acetate, 2-ethyl hexyl acetate, glycol diacetate, heptane, hexane, isobutyl acetate, isooctane, isopropyl acetate, methyl ethyl ketone, tetrahydrofuran or tetrachloroethylene or mixtures of two or more of the solvents mentioned. If the reaction components are themselves liquid or if at least one or more of the reaction components form a solution or dispersion of other, insufficiently liquid reaction components, there is no need at all to use solvents. A solventless reaction is preferred for the purposes of the invention.

To accelerate the reaction, the temperature is normally increased. For example, the reaction mixture may be heated to around 40 to 80 degrees C. The exothermic reaction which begins then provides for an increase in temperature. The temperature of the reaction mixture is kept at about 70 to about 110 degrees C., for example at about 85 to 95 degrees C. or more particularly at about 75 to about 85 degrees C. If necessary, the temperature may be regulated by suitable external measures, for example heating or cooling.

Catalysts widely used in polyurethane chemistry may optionally be added to the reaction mixture to accelerate the reaction. Dibutyl tin dilaurate or diazabicyclooctane (DABCO) may be added, for example. Where it is desired to use a catalyst, the catalyst is generally added to the reaction mixture in a quantity of about 0.001% by weight or about 0.01 to about 0.2% by weight, based on the mixture as a whole.

The reaction time depends upon the polyol used, the monomeric polyisocyanate, the reaction temperature and the catalyst present, if any. The total reaction time is typically, for example, about 30 minutes to about 20 hours.

A low content of monomeric polyisocyanate in the polyurethane prepolymer may be achieved, if desired, by removing the monomeric polyisocyanate from the reaction product after the reaction of at least one monomeric polyisocyanate with at least one polyol. The purification step may be carried out by methods known per se, such as distillation, extraction, chromatography or crystallization and combinations thereof.

The product obtained in this way is a polyurethane prepolymer with a low content of monomeric polyisocyanate which carries at least two terminal isocyanate groups.

In one embodiment of the invention, the isocyanate-functionalized polyurethane prepolymer belongs to the group of NCO-terminated polyurethane prepolymers obtainable by reaction of polyols with IPDI, MDI, HDI and/or TDI.

In another embodiment, the polyurethane prepolymer belongs to the group of NCO-terminated PU prepolymers obtainable by reacting a mixture of a polyether polyol and/or polyester polyol having a molecular weight of about 800 to about 2,000 and a polyether polyol and/or polyester polyol having a molecular weight of about 200 to about 700 with IPDI, MDI, HDI and/or TDI.

The molar ratio between the polyisocyanate and the polyol may be gauged in such a way that, after the reaction of these components, the PU prepolymer may still, for example, contain 1 to 30% by weight or alternatively 1 to 20% by weight free NCO groups.

The polyurethane prepolymer containing free NCO groups may then mixed with the other components of the reactive adhesive. In one embodiment, the reactive adhesive is a two part adhesive, wherein the isocyanate-functionalized polyurethane prepolymer is kept separated (as Part A) from Part B (containing the acidic hydrogen-containing hardener) until shortly before the adhesive is to be used to bind two or more substrates together.

The reactive adhesive additionally contains at least one of the following (meth)acrylate-functionalized compounds: polyester (meth)acrylates containing hydroxyl functional groups, adducts of epoxy-functionalized poly(meth)acrylic resins and (meth)acrylic acids, polybutadiene (meth)acrylates, and polyoxyalkylene ether mono(meth)acrylates. Mixtures of one or more of these compounds may be present. In the embodiment of the invention where the adhesive is utilized as a two part adhesive, the (meth)acrylate functionalized compound(s) may be admixed with one or both parts (i.e., Part A and/or Part B) of the reactive adhesive. In one embodiment, the (meth)acrylate-functionalized compound contains two or more hydroxyl groups per molecule and is present only in Part B of the reactive adhesive.

Suitable polyester (meth)acrylates containing hydroxyl functional groups include those substances which comprise a polyester backbone (which may be linear or branched) and which contain at least one (meth)acrylate group and at least one—OH group (that is not part of a carboxylic acid group) per molecule.

In one embodiment, such polyester (meth)acrylates may be obtained by reacting a polyester polyol containing two or more hydroxyl groups per molecule with less than a stoichiometric amount of acrylic acid, methacrylic acid or a reactive derivative thereof (e.g., a C1-C3 alkyl ester or an acyl halide) such that only partial esterification of the hydroxyl groups takes place. In a preferred embodiment, however, the polyester (meth)acrylate containing at least one hydroxyl group per molecule is obtained by reacting a polyester (meth)acrylate containing at least one (meth)acrylate group and at least one carboxylic acid group (—CO₂H) per molecule with an epoxide or mixture of epoxides (such polyester (meth)acrylate may be present as a component of a mixture containing other compounds, such as polyester (meth)acrylates that do not contain any carboxylic acid groups). In one embodiment, the epoxide is a mono-epoxide. In another embodiment, the epoxide is a mono-glycidyl ether of an aliphatic alcohol. In yet another embodiment, the aliphatic alcohol may, for example, be a C8 to C22 aliphatic alcohol (e.g., a straight chain and/or branched and/or alicyclic alcohol) or mixture thereof. Alternatively, the epoxide could be an aliphatic mono-epoxide having an epoxy group at one end of the molecule and a hydroxyl group at the other end of the molecule, with 2 to 22 (e.g., 4 to 20 or 6 to 18) methylene (CH₂) groups linking these two functional groups. When incorporated into the adhesives of the present invention, the polyester (meth)acrylates thereby obtained help to improve the flexibility and adhesive properties of the adhesives when cured.

The polyester (meth)acrylate containing at least one (meth)acrylate group and at least one carboxylic acid group (—CO₂H) per molecule may be reacted with the epoxide using any suitable conditions effective to cause the carboxylic acid group to ring-open the epoxy group of the epoxide. For example, if the mixture of reactants is solid or highly viscous at the desired reaction temperature, it is preferably dissolved in a suitable solvent or a reactive diluent (i.e., a diluent that is capable of being polymerized or cured when irradiated) that can be left in the reaction product obtained. Reaction temperatures will be dependent upon the reactants used, among other factors, but typically will be from about 80 to about 140 degrees C. The reaction may be conducted in the presence of a suitable catalyst such as, for example, a tertiary phosphine, tertiary amine, metal alkoxide, tetraalkyl ammonium halide, or chromium (III) salt. Generally speaking, it will be desirable to utilize a stoichiometric ratio of epoxy: carboxylic acid of from about 0.8:1 to about 1:0.8 or about 1:1. In one embodiment of the invention, all or essentially all of the carboxylic acid functional groups in the polyester (meth)acrylate are reacted with the epoxide. However, it is also possibly to react only a portion of the carboxylic acid groups.

In one embodiment of the invention, the polyester (meth)acrylate reactant is a chlorinated polyester (meth)acrylate (prepared, for example, by reacting (in an esterification reaction) acrylic acid or methacrylic acid with a chlorinated hydroxy-functional polyester obtained by condensation polymerization of one or more chlorine-containing polycarboxylic acids or anhydrides or esters thereof, such as chlorendic anhydride, with one or more polyols. The polyester (meth)acrylate contains at least some residual carboxylic acid groups which react with epoxide. For example, the chlorinated polyester acrylate sold by the Sartomer Company under the brand name CN 738 may be utilized as a starting material in the reaction with epoxide.

To illustrate one embodiment of the invention, the polyester (meth)acrylate may correspond to the following general structure: 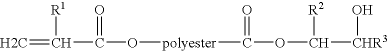
H2C═CH—C—O-polyester-C—O—CH—CHR³
wherein R1 is H or CH₃, “polyester” is a polyester moiety obtained, for example, by condensation polymerization of one or more dicarboxylic acids and one or more diols, as described previously herein in connection with the polyester polyols used to prepare the isocyanate-functionalized polyurethane prepolymer, R² is H or a C1-C20 alkyl group, and R³ is H, a C1-C20 alkyl group or —CH₂OR⁴, where R⁴ is a C1-C20 alkyl group. In one embodiment, the polyester moiety contains chlorine atoms (i.e., the polyester moiety is chlorinated). As will be apparent to one of ordinary skill in the art, the terminal groups of the “polyester” moiety in the above-stated structure will be derived from the diols utilized in the synthesis of the polyester (e.g., where the diol is 1,4-butanediol, the terminal group will be —CH₂CH₂CH₂CH₂O—).

While it is not necessary for the laminating adhesive to contain any polyester (meth)acrylates containing hydroxyl functional groups, in certain embodiments of the invention the adhesive will contain from about 5 to about 40 weight % or about 15 to about 30 weight % of one or more polyester (meth)acrylates containing hydroxyl functional groups.

As mentioned previously, the adhesives of the present invention may contain one or more adducts of epoxy-functionalized poly(meth)acrylic resins and (meth)acrylic acids. Such adducts have been found to provide significant improvements in the tensile strength of the cured adhesive at 100% elongation, in addition to enhancing adhesive properties. Suitable adducts of epoxy-functionalized poly(meth)acrylic resins and (meth)acrylic acids include the products obtained by reacting poly(meth)acrylic resins bearing one or more epoxy groups with acrylic acid and/or methacrylic acid. The (meth)acrylic acid ring-opens the epoxy group, thereby creating a (meth)acrylate functional group attached to the poly(meth)acrylic resin backbone. The adduct also contains one or more hydroxyl groups as a result of the ring-opening of the epoxy groups.

The epoxy-functionalized poly(meth)acrylic resin may be any polymer or copolymer formed by copolymerization of ethylenically unsaturated monomers, at least one of which is a (meth)acrylic monomer containing an epoxy group. Suitable (meth)acrylic monomers containing an epoxy group include, for example, glycidyl acrylate and glycidyl methacrylate and mixtures thereof. Monomers suitable for copolymerization with the epoxy group-containing (meth)acrylic monomer(s) include alkyl (meth)acrylates such as methyl (meth)acrylate, ethyl (meth)acrylate, butyl (meth)acrylates, 2-ethylhexyl (meth)acrylate, cyclohexyl (meth)acrylate, tetrahydrofurfuryl (meth)acrylate, bornyl (meth)acrylates, vinyl arenes such as styrene and alpha methyl styrene, (meth)acrylonitrile, olefins such as ethylene and propylene, and the like. The epoxy-functionalized poly(meth)acrylic resin may be prepared by a variety of methods. For example, a free radical initiator may be used to induce polymerization of the monomer or monomer mixture.

The epoxy-functionalized poly(meth)acrylic resin may, for example, may be a glycidyl-functional polyacrylic resin. Such resins provide excellent adhesion, flexibility, tensile strength and chemical resistance. The (meth)acrylic acid adducts prepared therefrom generally have excellent solubility in commonly used monomers polymerizable by exposure to UV light as well as polyol hardeners, making them especially suitable for use in the dual cure adhesives of the present invention. Epoxy-functionalized poly(meth)acrylic resins of this type may, for example, be relatively low molecular weight resins in the form of granulates having softening points of about 90 to about 110 degrees C., a glass transition temperature of from about 70 to about 75 degrees C., and an epoxy equivalent weight from from about 250 to about 350. The softening temperature preferably is high enough to provide stability, but low enough to allow good flow.

The epoxy-functionalized poly(meth)acrylic resin and the (meth)acrylic acid may be reacted using any suitable conditions effective to cause the carboxylic acid group of the (meth)acrylic acid to ring-open the epoxide group of the epoxy-functionalized poly(meth)acrylic resin. For example, if the epoxy-functionalized poly(meth)acrylic resin is solid or highly viscous at the desired reaction temperature, it is preferably dissolved in a suitable solvent. The solvent may be, for example, a reactive diluent such as TPGDA that is stable at the reaction temperature and that does not need to be removed from the reaction product prior to formulating the reaction product into the dual cure adhesives of the present invention. Reaction temperatures will be dependent upon the reactants used, among other factors, but typically will be from about 80 to about 140 degrees C. The reaction may be conducted in the presence of a suitable catalyst such as, for example, a tertiary phosphine, tertiary amine, metal alkoxide, tetraalkyl ammonium halide, or chromium (III) salt. Generally speaking, it will be desirable to utilize a stoichiometric ratio of epoxy: carboxylic acid of from about 0.8:1 to about 1:0.8 or about 1:1. In one embodiment of the invention, all or essentially all of the epoxide functional groups in the epoxy-functionalized poly(meth)acrylic resin are reacted with the (meth)acrylic acid.

While it is not necessary for the laminating adhesive to contain any adducts of epoxy-functionalized poly(meth)acrylic resins and (meth)acrylic acids, in certain embodiments of the invention the adhesive will contain from about 1 to about 25 weight % or about 2 to about 15 weight % of one or more adducts of epoxy-functionalized poly(meth)acrylic resins and (meth)acrylic acids.

The polybutadiene (meth)acrylate which may be present in the radiation-curable laminating adhesive may be any polybutadiene that has been modified or derivatized so as to attach one or more acrylate and/or methacrylate functional groups onto the polybutadiene polymer chain. The (meth)acrylate functional groups may, for example, be on the terminal positions of the polybutadiene and/or may be attached along the linear backbone of the polybutadiene. Typically, the polybutadiene (meth)acrylate will have a number average molecular weight within the range of from about 1000 to about 6000.

Suitable polybutadiene (meth)acrylates may be synthesized using any of the methods known in the art. For example, a process comprising a transesterification reaction between a hydroxyl terminated alkoxylated polybutadiene resin and a low molecular weight (meth)acrylate ester may be used, as described, for example, in WO 2005/023887. Polybutadiene (meth)acrylates containing free hydroxyl groups may be obtained by reacting a hydroxy terminated polybutadiene with an anhydride to form a carboxyl terminated polybutadiene derivative and then reacting the derivative with an epoxide such as glycidyl methacrylate, as described, for example, in U.S. Pat. No. 5,587,433. Alternatively, the polybutadiene (meth)acrylate may be prepared by reacting a hydroxyl terminated polybutadiene with (meth)acrylic acid or a reactive derivative thereof such as a lower alkyl ester or acid halide. Still another approach would be to react a hydroxyl terminated polybutadiene with an excess of a diisocyanate to form an NCO-terminated prepolymer and then reacting the prepolymer with a hydroxy-functionalized (meth)acrylate such as hydroxypropyl acrylate.

While it is not necessary for the laminating adhesive to contain any polybutadiene (meth)acrylate, in certain embodiments of the invention the adhesive will contain from about 0.1 to about 15 weight % or about 0.5 to about 5 weight % of one or more polybutadiene (meth)acrylates.

The adhesives of the present invention may be formulated using one or more polybutadiene (meth)acrylates from commercial sources, such as, for example, CN301 and CN303 polybutadiene dimethacrylates from the Sartomer Company, CN302 and CN307 polybutadiene diacrylate from the Sartomer Company, or RICACRYL 3500, RICACRYL 3801 or RICACRYL 3100 from the Sartomer Company.

The adhesives of the present invention may contain one or more polyoxyalkylene ether mono(meth)acrylates. Such (meth)acrylate-functionalized compounds may be described in general as radiation-curable compounds containing two or more oxyalkylene groups as well as one methacrylate or acrylate group per molecule. The oxyalkylene groups may be oxyethylene, oxypropylene (linear or branched), oxybutylene (linear or branched) or the like or combinations thereof.

These types of compounds are known in the art and are described, for example, in U.S Pat. Nos. 4,876,384; 5,053,554; 5,110,889; 5,159,119; 5,243,085; and 5,292,965, each of which is incorporated herein by reference in its entirety. Suitable polyoxyalkylene ether mono(meth)acrylates are also available from commercial sources such as the Sartomer Company and Cognis Corporation.

Illustrative polyoxyalkylene ether mono(meth)acrylates which can be utilized in the present invention include compounds having the following general structure:

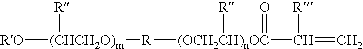

where R is C2-C10, preferably C2-C6 (linear, cyclic or branched, aromatic, araliphatic or preferably aliphatic, such as —CH₂CH₂—, —CH₂CH(CH₃)—, —CH₂CH(CH₃)CH₂—, or —CH₂C(CH₃)₂CH₂—, derived for example from ethylene glycol, 1,2-propanediol, 1,3-propanediol, 1,4-butanediol, 2-methyl-1,3-propanediol, neopentyl glycol, 1,6-hexanediol, cyclohexanedimethanol), R′ is C1-C20, preferably C1-C6 (linear, cyclic or branched, aromatic araromatic or preferably aliphatic, such as methyl, ethyl, propyl, isopropyl, butyl, isobutyl, amyl or n-hexyl), the R″ groups are the same or different and are selected from H, CH₃, or CH₃CH₂, R′″ is H or CH₃, m is 0 to 6, n is 0 to 6, and m+n is at least 1 and preferably no greater than about 6.

Specific polyoxyalkylene ether mono(meth)acrylates suitable for use in the present invention include, for example:

Mono-methoxy propoxylated and/or ethoxylated 1,6-hexanediol mono(meth)acrylate containing an average of from about 2 to about 6 moles of reacted ethylene oxide and/or propylene oxide per molecule.

Mono-methoxy propoxylated and/or ethoxylated neopentyl glycol mono(meth)acrylate containing an average of from about 2 to about 6 moles of reacted ethylene oxide and/or propylene oxide per molecule.

Mono-methoxy propoxylated and/or ethoxylated trans-1,4-cyclohexane dimethanol mono(meth)acrylate containing an average of from about 2 to about 6 moles of reacted ethylene oxide and/or propylene oxide per molecule.

Mono-methoxy propoxylated and/or ethoxylated 2,2,4-trimethyl-1,3-pentanediol mono(meth)acrylate containing an average of from about 2 to about 6 moles of reacted ethylene oxide and/or propylene oxide per molecule.

Mono-methoxy diethylene glycol mono(meth)acrylate.

Mono-ethoxy diethylene glycol mono(meth)acrylate (also known as 2-(2-ethoxyethoxy) ethyl acrylate).

Mono-butoxy diethylene glycol mono(meth)acrylate.

Mono-propoxy diethylene glycol mono(meth)acrylate.

Mono-methoxy tripropylene glycol mono(meth)acrylate (for example, PHOTOMER 8061, available from the Sartomer Company).

Mono-tetrahydrofuryl propoxylated and/or ethoxylated mono(meth)acrylates, containing an average of from 2 to about 6 moles of reacted ethylene oxide and/or propylene oxide per molecule.

Neopentylglycol propoxylate (2) methylether monoacrylate is especially preferred for use in the present invention, as it acts as an excellent wetting agent. This monoacrylate is sold by Cognis Corporation under the trade name PHOTOMER 8127.

While it is not necessary for the laminating adhesive to contain any polyoxyalkylene ether mono(meth)acrylate, in certain embodiments of the invention the adhesive will contain from about 0.1 to about 20 weight % or about 0.5 to about 10 weight % of one or more polyoxyalkylene ether mono(meth)acrylates.

Besides one or more of the above-described (meth)acrylate-functionalized compounds, the reactive adhesives according to the invention may additionally contain at least one other type of compound which has at least one and preferably two functional groups polymerizable by exposure to UV light or electron beams (hereinafter referred to as “auxiliary radiation-curable compound”). Such auxiliary radiation-curable compound contains at least one group with an olefinically unsaturated double bond as the functional group(s) polymerizable by exposure to UV light or electron beams.

Acrylate or methacrylate esters with a functionality of two or more are particularly suitable as the auxiliary radiation-curable compound. Acrylate or methacrylate esters such as these include, for example, esters of acrylic or methacrylic acid with aromatic, aliphatic or cycloaliphatic polyols and acrylate esters of polyether alcohols.

Any of the large number of polyols already described previously as polyols for the production of the polyurethane prepolymer may be used as polyols for the production of an acrylate or methacrylate ester suitable for use as an auxiliary radiation-curable compound.

Acrylate esters of aliphatic polyols containing 2 to about 40 carbon atoms include, for example, neopentyl glycol di(meth)acrylate, 1,6-hexanediol di(meth)acrylate, trimethylol propane tri(meth)acrylate, pentaerythritol tetra(meth)acrylate and (meth)acrylate esters of sorbitol and other sugar alcohols. These (meth)acrylate esters of aliphatic or cycloaliphatic diols may be modified with an aliphatic ester or an alkylene oxide. The acrylates modified by an aliphatic ester comprise, for example, neopentyl glycol hydroxypivalate di(meth)acrylate, caprolactone-modified neopentyl glycol hydroxypivalate di(meth)acrylates and the like. The alkylene oxide-modified acrylate compounds include, for example, ethylene oxide-modified neopentyl glycol di(meth)acrylates, propylene oxide-modified neopentyl glycol di(meth)acrylates, ethylene oxide-modified 1,6-hexanediol di(meth)acrylates or propylene oxide-modified hexane-1,6-diol di(meth)acrylates or mixtures of two or more thereof.

Acrylate monomers based on polyether polyols include, for example, neopentyl glycol-modified (meth)acrylates, trimethylol propane di(meth)acrylates, polyethylene glycol di(meth)acrylates, polypropylene glycol di(meth)acrylates and the like. Trifunctional and higher acrylate monomers comprise, for example, trimethylol propane tri(meth)acrylate, pentaerythritol tri- and tetra(meth)acrylate, dipentaerythritol tetra(meth)acrylate, dipentaerythritol penta(meth)acrylate, dipentaerythritol hexa(meth)acrylate, caprolactone-modified dipentaerythritol hexa(meth)acrylate, pentaerythritol tetra(meth)acrylate, tris[(meth)acryloxyethyl]-isocyanurate, caprolactone-modified tris[(meth)acryloxyethyl]-isocyanurates or trimethylol propane tetra(meth)acrylate or mixtures of two or more thereof. Di-, tri- and tetrapropylene glycol diacrylate, neopentyl glycol propoxylate di(meth)acrylate, trimethylol propane tri(meth)acrylate, trimethylolpropane monoethoxytri(meth)acrylate and pentaerythritol triacrylate may be particularly mentioned.

(Meth)acrylate esters based on polyols containing urethane groups can be produced by reacting the polyols already mentioned with the monomeric polyisocyanates already mentioned to form at least partly OH-terminated polyurethane prepolymers which are esterified with (meth)acrylic acid to form the corresponding mono- or diesters.

In one particular embodiment, a compound obtainable by reacting a polyisocyanate or an isocyanate-functionalized polyurethane prepolymer with a compound containing both at least one (meth)acrylate group and at least one acidic hydrogen-containing functional group (such as a hydroxyl group) may be utilized as an auxiliary radiation-curable compound. One or more residual (unreacted) isocyanate groups may be present in such compound.

Auxiliary radiation-curable compounds which are flowable (liquid) at room temperature, especially mono-esters of acrylic or methacrylic acid, are particularly suitable as so-called reactive diluents in the reactive adhesives of the present invention. Particularly suitable compounds are, for example, the acrylates or methacrylates of aromatic, cycloaliphatic, aliphatic, linear or branched C₄₋₂₀ monoalcohols or of corresponding ether alcohols, for example n-butyl acrylate, 2-ethylhexyl acrylate, octyl/decyl acrylate, isobornyl acrylate, 3-methoxybutyl acrylate, 2-phenoxyethyl acrylate, benzyl acrylate or 2-methoxypropyl acrylate.

The radiation-curable components (i.e., the total amount of (meth)acrylate-functionalized compound(s) plus auxiliary radiation-curable compound(s), if any) may make up as much as about 80% by weight of the reactive adhesive according to the invention, but preferably less, for example, about 40% by weight or less, about 30% by weight or less or about 20% by weight or less. The use of smaller quantities is equally possible. Thus, the reactive adhesive according to the invention may also contain only 10% by weight or a quantity of about 0.5 to about 8% by weight of radiation-curable components.

In addition to one or more PU prepolymers, one or more radiation-curable compounds and one or more hardeners, the reactive adhesive may contain at least one photoinitiator which initiates the polymerization of olefinically unsaturated double bonds under UV irradiation.

Accordingly, a photoinitiator capable of initiating the radical polymerization of olefinically unsaturated double bonds on exposure to light with a wavelength of about 215 to about 480 nm may be used. In principle, any commercially available photoinitiators which are compatible with the adhesive according to the invention, i.e., which form at least substantially homogeneous mixtures, may be used as photoinitiators for the purposes of the present invention.

Suitable photoinitiators include, for example, phosphine oxide type photoinitiators and alpha-hydroxyketo type photoinitiators.

Conventional low molecular weight photoinitiators may contribute to the formation of “migrates” in laminates. Migrates include the photoinitiators themselves present in the reactive adhesive and also fragments of the photoinitiators which can be formed on exposure of the adhesive to UV light. In certain circumstances, for example in the production of laminates intended for the packaging of foods, the presence of migratable compounds in the reactive adhesive should be avoided. The content of migratable compounds in the reactive adhesive according to the invention can generally be further reduced if the photoinitiator has a molecular weight which makes migration very difficult or even impossible.

Accordingly, in a preferred embodiment, the reactive adhesive may contain one or more photoinitiators with a molecular weight of more than about 200 g/mol. Commercially available photoinitiators which meet this requirement are, for example, IRGACURE 651, IRGACURE 369, IRGACURE 907, IRGACURE 784, SPEEDCURE EDB and SPEEDCURE ITX.

However, photoinitiators which meet the above-stated requirement in regard to their molecular weight can also be obtained by reacting a low molecular weight photoinitiator containing at least one acidic hydrogen atom, for example, an amino group or an OH group, with a high molecular weight compound containing at least one isocyanate group, thereby providing a polymer-bound photoinitiator. Compounds containing more than one photoinitiator molecule, for example, two, three or more photoinitiator molecules, may be used as the photoinitiator. Compounds such as these can be obtained, for example, by reacting polyols with suitable polyisocyanates and photoinitiators containing at least one acidic hydrogen atom.

Suitable polyols are any of the polyols mentioned above, but especially neopentyl glycol, glycerol, trimethylol propane, pentaerythritol and alkoxylation products thereof with C₂₋₄ alkylene oxides. Other suitable polyols are the reaction products of trihydric alcohols with caprolactone, for example, the reaction product of trimethylol propane with caprolactone.

In another embodiment of the present invention, the adhesive contains a photoinitiator obtainable by reacting an at least trihydric alcohol with caprolactone to form a polycaprolactone containing at least three OH groups with a molecular weight of about 300 to about 900 and then linking the polycaprolactone to 1-[4-(2-hydroxyethoxy)-pheny-1]-2-hydroxy-2-methylpropan-1-one by means of a monomeric polyisocyanate.

Suitable monomeric polyisocyanates for reaction with the polyols mentioned are, for example, any of the monomeric polyisocyanates mentioned in the present specification. However, the 2,4-isomer and the 2,6-isomer of toluene diisocyanate (TDI) are particularly preferred, the isomers being used either in their pure form or in the form of a mixture.

Suitable photoinitiators for producing the polymer-bound photoinitiators are any photoinitiators that contain an acidic hydrogen atom. 1-[4-(2-hydroxyethoxy)-phenyl]-2-hydroxy-2-methylpropan-1-one (IRGACURE 2959), which has one primary OH group, may be utilized, for example.

The photoinitiators used may also be prepared by using a small quantity of photoinitiator molecules containing at least one acidic hydrogen atom in the production of the isocyanate-functionalized polyurethane prepolymer. In this way, the photoinitiator is attached to a molecule of the PU prepolymer.

The photoinitiator may also be attached to a polymer chain, for example to PU prepolymer, by adding the photoinitiator containing a corresponding functional group to the reactive adhesive in monomeric form and then reacting it with a corresponding polymeric component, for example PU prepolymer, for example during storage of the reactive adhesive.

It is also possible to provide the photoinitiator with a functional group polymerizable by exposure to UV light or to electron beams, in which case the functional group polymerizable by exposure to UV light or to electron beams can be attached to the photoinitiator, for example by reaction of the photoinitiator with an unsaturated carboxylic acid. Suitable unsaturated carboxylic acids are, for example, acrylic acid and methacrylic acid. The reaction products of IRGACURE 2959 with acrylic acid or methacrylic acid are suitable for the purposes of the invention, for example.

Accordingly, a compound which contains both a photoinitiator and a functional group polymerizable by exposure to UV light or to electron beams or a functional group capable of reacting with a compound containing at least one acidic hydrogen atom may be used as a component of the reactive adhesive of the present invention.

The reactive adhesive according to the invention may contain one or more photoinitiators in a quantity of 0 to 15% by weight, based on the reactive adhesive as a whole.

In order to have the reactive adhesive develop a certain ultimate strength very quickly, i.e. to harden at a high hardening rate, for example to enable the bonded materials to be rapidly further processed, it is desirable to incorporate an acidic hydrogen-containing hardener into the reactive adhesive. In one embodiment, the hardener (comprising all or a portion of Part A) is kept separate from the isocyanate-functionalized polyurethane prepolymer (comprising all or a portion of Part B) until shortly before the adhesive is to be used. A two part adhesive is thereby provided by the present invention if so desired. Accordingly, the present invention also relates to a reactive adhesive that, in the form of a two-part reactive adhesive, contains as hardener up to 60% by weight of a compound containing at least two functional groups each having at least one acidic hydrogen atom. The molecular weight of the hardener is in the range from 50 to 10,000 g/mol, alternatively in the range from 50 to 6,000 g/mol and more particularly in the range from 50 to 3,000 g/mol. The hardener is preferably a compound containing at least two functional groups each having at least one acidic hydrogen atom or a mixture of two or more such compounds which are capable of reacting with the isocyanate groups of the PU prepolymer.

Suitable functional groups having at least one acidic hydrogen atom which are reactive with the isocyanate functional groups of the PU prepolymer are, in particular, primary or secondary amino groups, mercapto groups or OH groups.

The hardener is generally used in such a quantity in the reactive adhesive that the ratio of isocyanate groups in the isocyanate-functionalized polyurethane prepolymer to acidic hydrogen groups of the hardener is about 5:1 to about 1:1 and more particularly about 2:1 to about 1:1.

The reactive adhesive according to the invention may, in one embodiment, contain at least one compound bearing at least two OH groups per molecule as a hardener, hereinafter referred to as a “polyol hardener”.

The compounds useful as polyol hardeners generally have a functionality (number of hydroxyl groups per molecule) of at least about two. The polyol hardener may contain a certain percentage of compounds with a higher functionality, for example with a functionality of three, four or more. The total (average) functionality of the polyol hardener component used in the adhesives of the present invention may be, for example, about two (for example, where only difunctional compounds are used as the polyol hardener) or more, for example, about 1.2, 2.2, 2.5, 2.7 or 3. The polyol hardener component may have an even higher functionality, for example about four or more.

Any of the polyols mentioned in the present specification in connection with the preparation of the isocyanate-functionalized polyurethane prepolymer may be used as the polyol hardener.

The reactive adhesive according to the invention generally has a viscosity of 100 mPa·s to 26,000 mPa·s at 70 degrees C. (Brookfield viscosity, RVT DV-II Digital Viscosimeter, spindle 27) immediately after mixing of the components of the adhesive. In certain embodiments of the invention, the viscosity of the adhesive is selected so that the adhesive has a viscosity at typical application temperatures of about 1,000 mPa·s to about 5,000 mPa·s (Brookfield viscosity, RVT DV-1II Digital Viscosimeter, spindle 27). Typical application temperatures are, for example, about 25 to about 70 degrees C. in the production of flexible packaging films, about 70 to about 80 degrees C. in the lamination of high-gloss films and about 80 to about 130 degrees C. in textile applications.

The reactive adhesive according to the invention may optionally contain additives in addition to the other components described herein. The additives may make up as much as about 50% by weight of the adhesive as a whole.

Additives suitable for use in accordance with the invention include, for example, plasticizers, catalysts (e.g., substances capable of enhancing the rate of reaction between the isocyanate-functionalized polyurethane and the hardener), stabilizers, antioxidants, adhesion promoters, anti-foam agents, coupling agents, dyes and fillers. In preferred embodiments of the invention, the adhesive is free or essentially free of any or all of the following types of additives: non-reactive solvents, plasticizers, monomeric isocyanate-containing compounds.

The optional plasticizers used include, for example, plasticizers based on phthalic acid, more especially dialkyl phthalates, including phthalic acid esters which have been esterified with a linear alkanol containing about 6 to about 14 carbon atoms. Diisononyl or diisotridecyl phthalate may be utilized, for example.

Other suitable plasticizers include benzoate plasticizers, for example, sucrose benzoate, diethylene glycol dibenzoate and/or diethylene glycol benzoate, in which around 50 to around 95% of all the hydroxyl groups have been esterified, phosphate plasticizers, for example, t-butyl phenyl diphenyl phosphate, polyethylene glycols and derivatives thereof, for example diphenyl ethers of poly(ethylene glycol), liquid resin derivatives, for example, the methyl esters of hydrogenated resin, vegetable and animal oils, for example glycerol esters of fatty acids and polymerization products thereof.

Stabilizers or antioxidants suitable for use as additives in accordance with the present invention include phenols, sterically hindered phenols of high molecular weight, polyfunctional phenols, sulfur- and phosphorus-containing phenols or amines. Phenols suitable for use as additives in accordance with the invention are, for example, hydroquinone, hydroquinone methyl ether, 2,3-(di-tert-butyl)-hydroquinone, 1,3,5-trimethyl-2,4,6-tris-(3,5-di-tert-butyl-4-hydroxybenzyl) benzene; butyl hydroxytoluene (BHT), pentaerythritol tetrakis-3-(3,5-ditert-butyl-4-hydroxyphenyl)propionate; n-octadecyl-3,5-ditert-butyl-4-hydroxyphenyl)-propionate; 4,4-methylene-bis-(2,6-di-tert-butylphenol); 4,4-thiobis-(6-tert-butyl-o-cresol); 2,6-di-tert-butylphenol; 2,6-di-tert.butyl-n-methylphenol; 6-(4-hydroxyphenoxy)-2,4-bis-(n-octylthio)-1,3,5-triazine; di-n-octadecyl-3,5-di-tert-butyl-4-hydroxybenzyl phosphonates; 2-(n-octylthio)-ethyl-3,5-ditert-butyl-4-hydroxybenzoate; and sorbitol hexa[3-(3,5-ditert-butyl-4-hydroxyphenyl)-propionate]; and amines such as p-hydroxydiphenylamine, N,N′-diphenylenediamine or phenothiazine.

The reactive adhesive according to the invention may additionally contain one or more adhesion promoters. Adhesion promoters are substances that improve the strength of the bond between an adhesive and a substrate surface. Typical adhesion promoters include, for example, ethylene/acrylamide comonomers, polymeric isocyanates, reactive organosilicon compounds and phosphorus derivatives. The phosphorus derivatives disclosed in WO 99/64529 (page 7, line 14 to page 9, line 5), for example 2-methacryloyloxyethyl phosphate, bis-2-(methacryloyloxyethyl)-phosphate or mixtures thereof, may used as adhesion promoters. (Meth)acrylic compounds containing carboxylic acids may also be used as adhesion promoters. Compounds of this type are disclosed, for example, in WO 01/16244 (page 7, line 7 to page 8, line 31) or in WO 00/29456 (page 11, line 15 to page 12, line 2). Commercially available products are obtainable, for example, from UCB Chemicals, B-1 620 Drogenbos, Belgium as products sold under the “Ebecryl” trademark, for example EBECRYL 168 or EBECRYL 170, as well as from the Sartomer Company, West Chester, Pa.

Still further additives may be incorporated in the reactive adhesives according to the invention in order to vary certain properties. These other additives include, for example, dyes, such as titanium dioxide, fillers, such as talcum, clay and the like. The adhesives according to the invention may optionally contain small quantities of thermoplastic polymers, for example ethylene/vinyl acetate (EVA), ethylene/acrylic acid, ethylene/methacrylate and ethylene/n-butyl acrylate copolymers which optionally impart additional flexibility, toughness and strength to the adhesive. Certain hydrophilic polymers may also be added, including, for example, polyvinyl alcohol, hydroxyethyl cellulose, hydroxypropyl cellulose, polyvinyl methyl ether, polyethylene oxide, polyvinyl pyrrolidone, polyethyl oxazolines or starch or cellulose esters, more particularly the acetates with a degree of substitution of less than 2.5. These hydrophilic polymers increase the wettability of the adhesives, for example.

In certain embodiments of the invention, the reactive adhesive may comprise:
about 35 to about 65% by weight of at least one isocyanate-functionalized polyurethane prepolymer;
about 15 to about 50% by weight of at least one hardener (preferably polyol hardener, especially polymeric polyol hardener(s) such as polyester polyols and polyether polyols;
about 1 to about 40% by weight of at least one(meth)acrylate-functionalized compound selected from the group consisting of polyester (meth)acrylates containing hydroxyl functional groups, adducts of epoxy-functionalized poly(meth)acrylic resins and (meth)acrylic acids, polybutadiene (meth)acrylates, and polyoxyalkylene ether mono(meth)acrylates;
0 to about 30% by weight of at least one auxiliary radiation-curable compound; and
0 to about 10% by weight of at least one photoinitiator.

Depending on the application envisaged, the reactive adhesive according to the invention may additionally contain up to 60% by weight of any of the inert solvents already mentioned in connection with the production of the isocyanate-functionalized polyurethane prepolymer. In a preferred embodiment of the invention, however, the adhesive is essentially free of any such solvents.

Basically, the reactive adhesive according to the invention may be used in the bonding of various materials. Materials suitable for bonding include, for example, wood, metal, glass, plant fibers, stone, paper, cellulose hydrate, plastics, such as polystyrene, polyethylene, polypropylene, polyethylene terephthalate, polyvinyl chloride, copolymers of vinyl chloride and vinylidene chloride, copolymers of vinyl acetate olefins, polyamides, or metal foils, for example of aluminium, lead or copper.

In a preferred embodiment, the reactive adhesive according to the invention is used in the production of multilayer materials. The reactive adhesive according to the invention is particularly suitable for multilayer materials (e.g., flexible laminates) used in the packaging of foods.

Accordingly, the present invention also relates to a process for the production of multilayer materials which is characterized in that a reactive adhesive according to the invention is used. In another preferred embodiment, the multilayer materials which can be produced using the reactive adhesive according to the invention are film laminates obtainable by the part- or whole-surface bonding of films (including the bonding of films to other thin, flexible substrates such as foils).

The reactive adhesives according to the invention may be applied to the materials, particularly films, to be bonded by machines typically used for such purposes, for example by conventional laminating machines. The application of the reactive adhesive in liquid form to a film to be bonded to form a laminate is particularly suitable. The film thus coated with the reactive adhesive is laminated, optionally under pressure, with at least a second film and then exposed to UV light or electron beams.

In one particular embodiment of the process, the film or other substrate coated with the reactive adhesive is first transferred to an irradiation zone where the polymerization reaction, i.e., crosslinking, of the individual radiation-curable components, is initiated by exposure to UV radiation or electron beam radiation. The reactive adhesive according to the invention becomes tacky, for example, develops contact- or, preferably, pressure-sensitive adhesive properties, under the effect of the irradiation and the accompanying crosslinking reaction of the individual radiation-curable components present in the reactive adhesive. After irradiation, the first film coated with the irradiated reactive adhesive is laminated, optionally under pressure, with at least a second film. This procedure is advantageous particularly when two films that are not permeable to the radiation necessary for initiating polymerization are to be bonded to one another.

Whereas no other auxiliaries are required when crosslinking is initiated by electron beams, polymerization by UV light generally requires the presence of a photoinitiator.

In another embodiment of the invention, however, the film or other substrate coated with the reactive adhesive is laminated to at least one additional film or other substrate prior to initiating polymerization of the radiation-curable components in the adhesive by exposing the adhesive to radiation.

The described bonding and laminating processes may be repeated several times so that laminates consisting of more than two bonded layers can be produced.

The described bonding and laminating processes can be carried out in an inert gas atmosphere, i.e., in the presence of such inert gases as nitrogen. However, the described bonding and laminating processes with the reactive adhesive according to the invention may also readily be carried out in a normal atmosphere such as typically prevails in the production shops.

Accordingly, the present invention also relates to a multilayer material produced by the process according to the invention using the reactive adhesive according to the invention.

The reactive adhesive according to the invention may be applied to the surfaces to be bonded by any suitable process, for example, by spraying, knife coating, three/four roller application units where a solventless reactive adhesive is used or two-roller application units where a solvent-containing reactive adhesive is used.

The film or films to be coated or adhered to each other using the adhesive formulations of the present invention may be comprised of any of the materials known in the art to be suitable for use in flexible packaging, including both polymeric and metallic materials as well as paper (including treated or coated paper). Thermoplastics are particularly preferred for use as at least one of the layers. The materials chosen for individual layers in a laminate are selected to achieve specific desired combinations of properties, e.g., mechanical strength, tear resistance, elongation, puncture resistance, flexibility/stiffness, gas and water vapor permeability, oil and grease permeability, heat sealability, adhesiveness, optical properties (e.g., clear, translucent, opaque), formability, merchantability and relative cost. Individual layers may be pure polymers or blends of different polymers. The polymeric layers are often formulated with colorants, anti-slip, anti-block, and anti-static processing aids, plasticizers, lubricants, fillers, stabilizers and the like to enhance certain layer characteristics.

Particularly preferred polymers for use in the present invention include, but not limited to, polyethylene (including low density polyethylene (LDPE), medium density polyethylene (MDPE), high density polyethylene (HPDE), high molecular weight, high density polyethylene (HMW-HDPE), linear low density polyethylene (LLDPE), linear medium density polyethylene (LMPE)), polypropylene (PP), oriented polypropylene, polyesters such as poly (ethylene terephthalate) (PET) and poly (butylene terephthalate) (PBT), ethylene-vinyl acetate copolymers (EVA), ethylene-acrylic acid copolymers (EAA), ethylene-methyl methacrylate copolymers (EMA), ethylene-methacrylic acid salts (ionomers), hydrolyzed ethylene-vinyl acetate copolymers (EVOH), polyamides (nylon), polyvinyl chloride (PVC), poly(vinylidene chloride) copolymers (PVDC), polybutylene, ethylene-propylene copolymers, polycarbonates (PC), polystyrene (PS), styrene copolymers, high impact polystyrene (HIPS), acrylonitrile-butadiene-styrene polymers (ABS), and acrylonitrile copolymers (AN).

The polymer surface may be treated or coated, if so desired. For example, a film of polymer may be metallized by depositing a thin metal vapor such as aluminum onto the film's surface. A layer of inorganic oxide may also be deposited upon the polymeric film. Coating the film with a layer of metal or inorganic oxide may enhance the barrier properties of the finished laminate. The polymer film surface may also be coated with anti-fog additive or the like or subjected to a pretreatment with electrical or corona discharges, or ozone or other chemical agents to increase its adhesive receptivity.

One or more layers of the laminate may also comprise a metal foil, such as aluminum foil, or the like. The metal foil will preferably have thickness of about 5 to 100 μm.

The individual films comprising the laminates of the present invention can be prepared in widely varying thicknesses, for example, from about 5 to about 200 microns. The films, foils, and laminating adhesive formulation can be assembled into the laminate by using any one or more of the several conventional procedures known in the art for such purpose. For instance, the adhesive formulation may be applied to the surface of one or both of two films/foils by means of extrusion, brushes, rollers, blades, spraying or the like and the film/foil surfaces bearing the adhesive composition brought together and passed through a set of rollers (often referred to as nip rollers) which press together the film/foils having the adhesive composition between the films/foils. The resulting laminate may be rolled or wound onto a reel. The adhesive may be applied by conventional techniques; e.g., by either a multi-roll application station if the adhesive system is of the solvent-free type and by a multiroll or by gravure roller if it is a solvent- or water-based adhesive system.

Typically, the rate at which the adhesive formulation is applied to the surface of a film or foil is in the range of about 0.2 to about 5 g/m². For example, where the adhesive is utilized as a two part adhesive, the two parts may be pumped from separate drums or tanks at from about room temperature to about 40° C., mixed in the desired ratio using standard methods and equipment (for example, a meter-mix unit) and applied using solventless application machinery having the capability of being heated from about 25° C. to about 90° C. The adhesive composition of the present invention thus may be utilized as a two component (two part) system wherein the two components are combined shortly before use. It may be desirable to heat the laminate at an elevated temperature (e.g., about 40° C. to about 100° C.) so as to accelerate full curing of the adhesive composition. Alternatively, the adhesive composition may be adjusted so as to be curable at approximately room temperature (e.g., about 20° C. to about 40° C.) over a period of from about 1 hour to about 7 days.

Generally speaking, the adhesive compositions of the present invention are believed to be largely chemically cured through the reaction of the formulation constituents containing isocyanate groups (e.g., the isocyanate-functionalized polyurethane prepolymer) and the constituents containing hydroxyl or other active hydrogen groups (e.g., the acidic hydrogen-containing hardener). However, curing can also be accomplished at least in part through moisture curing. Although sufficient moisture may be inherently present on the film or foil surfaces for this purpose, water may also be deliberately introduced through conventional methods if so desired. Curing of the adhesive compositions of the present invention additionally takes place as a result of the radiation-induced polymerization of the (meth)acrylate-functionalized compound(s) and any auxiliary radiation-curable compound(s) which may be present.

Laminates prepared using adhesives in accordance with the present invention may be used for packaging purposes in the same manner as conventional or known flexible laminated packaging films. The laminates are particularly suitable for forming into flexible pouch-shaped container vessels capable of being filled with a foodstuff and retorted. For example, two rectangular or square sheets of the laminate may be piled in the desired configuration or arrangement; preferably, the two layers of the two sheets which face each other are capable of being heat-sealed (welded) to each other. Three peripheral portions of the piled assembly are then heat-sealed to form the pouch. Heat-sealing can easily be accomplished by means of a heating bar, heating knife, heating wire, impulse sealer, ultrasonic sealer, or induction heating sealer.

The foodstuff is thereafter packed in the so-formed pouch. If necessary, gasses injurious to the foodstuff such as air are removed by known means such as vacuum degasification, hot packing, boiling degasification, or steam jetting or vessel deformation. The pouch opening is then sealed using heat. The packed pouch may be charged to a retorting apparatus and sterilized by heating to a temperature greater than about 100° C.

The invention is illustrated by the following Examples.

### EXAMPLES

### Example 1

This example demonstrates a dual curable adhesive suitable for use in laminating applications, particularly laminating polymeric film to metallic foil, and having both a suitable pot life and viscosity for such application.

| Component | Weight % | Source |
|---|---|---|
| TYCEL 7975¹ | 44.07 | Liofol (Henkel) |
| TYCEL 7276² | 25.93 | Liofol (Henkel) |
| Epoxy-Modified Polyester Acrylate³ | 22 | |
| SR 256⁴ | 5 | Sartomer |
| DAROCUR 1173⁵ | 3 | Ciba |

¹isocyanate-functionalized polyurethane prepolymer
²polyester polyol
³reaction product (adduct) obtained by reacting a chlorinated polyester acrylate containing residual carboxylic acid groups (CN 738, Sartomer Company) with C12-C14 aliphatic epoxy
⁴2-(2-ethoxyethoxy)ethyl acrylate
⁵(2-hydroxy-2-methyl propiophenone photoinitiator

The adhesive was applied to a 0.5 mil foil and a second layer of 48 or 92 gauge PET film was placed over the wet adhesive. The adhesive was cured by UV exposure through the PET film using a 300 w/in medium pressure mercury arc lamp (H bulb at 35% power) and 200 ft/minute conveyor speed. The bond strengths of the resulting laminates were determined by a T-peel test in a T-peel setting at 12 inches per minute on 1 inch wide strips. The results obtained are shown in Table I.

TABLE I

Bond Strength (lb)

| Laminate Structure | 1 Hour | 72 Hours |
|---|---|---|
| 48 ga PET/FOIL | 0.02 (peel) | 1.37 (stock tear) |
| 92 ga PET/FOIL | 0.01 (peel) | 2.96 (stock tear) |

### Example 2

This example demonstrates a dual cured adhesive in accordance with the invention which is suitable for use in forming two layer laminate structures (preferably film to foil) with a potlife and viscosity useful for such application. The adhesive provides improved adhesion at 100% tensile elongation and has a reduced tendency to form pinholes, thereby providing an improved appearance.

| Component | Weight % | Source |
|---|---|---|
| TYCEL 7276¹ | 25.93 | Liofol (Henkel) |
| CN 2201² | 10.4 | Sartomer |
| Adduct³ | 10 | |
| PHOTOMER 8127⁴ | 5 | Cognis |
| RESIFLOW L-37⁵ | 1 | Estron |
| DAROCUR 1173⁶ | 2 | Ciba |
| BD 592⁷ | 1.6 | Liofol (Henkel) |
| LA 1021-07⁸ | 44.07 | Liofol (Henkel) |

¹polyester polyol
²chlorinated polyester acrylate
³prepared by reacting glycidyl-functionalized acrylic resin with acrylic acid
⁴neopentylglycol propoxylate (2) methylether monoacrylate
⁵modified polyacrylate flow control agent
⁶2-hydroxy-2-methyl-phenyl-propan-1-one
⁷biuret of 1,6-hexane diisocyanate/amino-functional silane mixture
⁸isocyanate-functionalized polyurethane prepolymer

A suitable potlife and viscosity was achieved for laminating application at ambient temperature. The adhesive was applied to a 0.5 mil foil and a second layer of 48 or 92 gauge PET film was placed over the wet adhesive. The adhesive was cured by UV radiation through the PET film using a 300 w/in medium pressure mercury lamp (H bulb at 79% power) and 200 ft/minute conveyor speed. The bond strengths of the laminates were determined by a T-peel test in a T-peel setting at 12 inches per minute on 1 inch wide strips. A coating weight of 2.3 lb adhesive per ream was applied, with the results obtained shown in Table II.

TABLE II

| Laminate | Bond Strength (lb) | | | |
|---|---|---|---|---|
| Structure | 1 Hour | 1 Day | 2 Days | 3 Days |
| 48 gauge | 0.04 (peel) | 0.89 (peel) | 0.84 (peel) | 0.99 (peel) |
| PET/Foil | | | | |
| 92 gauge | 0.06 (peel) | 1.08 (stk split) | 1.16 (peel) | 1.15 (peel) |
| PET/Foil | | | | |

| | |
|---|---|
| Laminate | Tensile Strength (lb) |

| Structure | 2 Days | 3 Days |
|---|---|---|
| 48 gauge | 16.24 (stock tear) | 15.34 (stock tear) |
| PET/Foil | | |
| 92 gauge | 29.01 (stock tear) | 31.07 (stock tear) |
| PET/Foil | | |

### Example 3

This example demonstrates another laminating adhesive in accordance with the invention that exhibits suitable potlife and viscosity at typical application temperatures.

| Component | Weight % | Source |
|---|---|---|
| TYCEL 7276¹ | 33.34 | Liofol (Henkel) |
| CN 3100² | 5 | Sartomer |
| PHOTOMER 8127³ | 4.5 | Cognis |
| IRGACURE 819⁴ | 0.5 | Ciba |
| MA 2101⁵ | 56.66 | Bayer |

¹polyester polyol
²described by supplier as “low viscosity acrylate oligomer with hydroxyl functionality”; according to the supplier's MSDS, this product contains “low viscosity acrylic oligomer” (amount proprietary), “methacrylate acid ester” (amount proprietary), “acrylic ester” (up to 4 weight %), and “aliphatic urethane acrylate” (amount proprietary)
³neopentylglycol propoxylate (2) methylether monoacrylate
⁴bis(2,4,6-trimethylbenzoyl)-phenylphosphine oxide photoinitiator
⁵isocyanate-functionalized polyurethane prepolymer

The reactive adhesive exhibited suitable potlife and viscosity for application to substrates at ambient temperature. The adhesive was applied to a preformed laminate of foil and PE film and a third layer of printed PET was placed over the wet adhesive layer. The adhesive layer was cured by UV exposure through the PET film with a 300 w/in medium pressure mercury arc lamp, using a D bulb@ 100% power and 100 ftl/minute conveyor speed. The bond strengths of the laminates thereby obtained were determined by a T-peel test, using a T-peel configuration at 2 inches per minute on 1 inch wide strips. The results shown in Table III were obtained.

TABLE III

| | | Water | | | |
|---|---|---|---|---|---|
| Laminate | RT | Soak | Heat Seal | Heat Seal | Heat Seal |
| Structure | Bonds | Bonds | RT | 70° C. | 85° C. |
| PET/FOIL | 0.87 ST | 0.44 ST | | | |
| PET/prelam | | | 16.28 ST | 6.95 B/ST | 6.32 B/ST |
| Foil/PE | | | | | |

where:
ST = stock tear
B/ST = bridge stock tear at PET

### Examples 4 and 5

These examples demonstrate laminating adhesives in accordance with the invention that exhibit strong initial bond strengths.

### Example 4

| Component | Weight % | Source |
|---|---|---|
| TYCEL 7276¹ | 33.34 | Liofol |
| CN 3100² | 4 | Sartomer |
| CN 307³ | 2 | Sartomer |
| PHOTOMER 8127⁴ | 4 | Cognis |
| MA 2101⁵ | 56.66 | Bayer |

¹polyester polyol
²described by supplier as “low viscosity acrylate oligomer with hydroxyl functionality”
³polybutadiene diacrylate (functionality = 2)
⁴neopentylglycol propoxylate (2) methylether monoacrylate
⁵isocyanate-functionalized polyurethane prepolymer

### Example 5

| Component | Weight % | Source |
|---|---|---|
| TYCEL 7276¹ | 31.48 | Liofol (Henkel) |
| CN 3100² | 6 | Sartomer |
| PHOTOMER 8127³ | 6 | Cognis |
| MA 2101⁴ | 53.52 | Bayer |
| PE 230 resin⁵ | 3 | Liofol/Loctite |

¹polyester polyol
²described by supplier as “low viscosity acrylate oligomer with hydroxyl functionality”
³neopentylglycol propoxylate (2) methylether monoacrylate
⁴isocyanate-functionalized polyurethane prepolymer
⁵acrylate-functionalized polyester urethane oligomer

Both formulations exhibited suitable potlife and viscosity was achieved for the laminating applications at ambient temperature and 40° C. The adhesives were applied to a preformed foil/PE film laminate structure and a third layer of printed PET film was placed over the wet adhesive layer. The adhesive was EB cured through the PET film, using an electron beam dose of 3.5 Mrads at 125 Kv power. An adhesive coat weight of 1.0-1.5 lb/ream was applied. A nip temperature of 40° C. was employed. The bond strengths of the laminates and the heat seal bond strengths at ambient temperature (RT), 70° C. and 85° C. were determined by a T-peel test in a T-peel configuration at 12 inches per minute on 1 inch wide strips. The results obtained are shown in Table 4.

TABLE IV

| | Example 4 | Example 4 | Example 5 | Example 5 |
|---|---|---|---|---|
| | Adhesive | Adhesive | Adhesive | Adhesive |
| Laminate | PET/Foil | PET/Foil/PE | PET/Foil | PET/Foil/PE |
| Structure | | | | |
| 1 Hour Bond | 0.06 (P) | | 0.09 (P) | |
| Strength (lb) | | | | |
| Room Temp., | 1.03 (ST) | | 0.67 (ST) | |
| 4 Day Bond | | | | |
| Strength (lb) | | | | |
| Water Soak, | 0.57 (P) | | 1.09 (ST) | |
| 4 Day Bond | | | | |
| Strength (lb) | | | | |
| Heat Seal, | | 17.7 (ST) | | 16.93 (ST) |
| 4 Days, Room | | | | |
| Temp. (lb) | | | | |
| Heat Seal, | | 9.40 (B/ST) | | 7.62 (B/ST) |
| 4 Days, | | | | |
| 70° C. (lb) | | | | |
| Heat Seal, | | 6.36 (B/ST) | | 5.12 (B/ST) |
| 4 Days, | | | | |
| 85° C. (lb) | | | | |

Where
P = peel
ST = stock tear
B/ST = bridge stock tear

### Example 6

This example provides an adhesive in accordance with the invention that is suitable for use in forming three layer flexible laminates, such as film to foil to film.

| Component | Weight % | Source |
|---|---|---|
| TYCEL 7276¹ | 29.64 | Liofol (Henkel) |
| CN 3100² | 4 | Sartomer |
| SR 9041³ | 3.5 | Sartomer |
| PHOTOMER 8127⁴ | 2 | Cognis |
| IRGACURE 819⁵ | 0.5 | Ciba |
| MA 2101⁶ | 50.36 | Bayer |
| LA 1078-15⁷ | 10 | Liofol (Henkel) |

¹polyester polyol
²described by supplier as “low viscosity acrylate oligomer with hydroxyl functionality”
³pentaacrylate ester
⁴neopentylglycol propoxylate (2) methylether monoacrylate
⁵bis(2,4,6-trimethylbenzoyl)-phenylphosphineoxide photoinitiator
⁶isocyanate-functionalized polyurethane prepolymer
⁷isocyanate-functionalized polyurethane prepolymer

The adhesive obtained by mixing the above-listed components had suitable potlife and viscosity for application to flexible substrates at ambient temperature. The adhesive was applied to a preformed foil to PE film laminate and then a third layer of 48 gauge printed PET was placed over the wet adhesive layer. The adhesive layer was cured by UV radiation through the PET film using a 300 w/in medium pressure mercury lamp (D bulb@100% power, 100 ft/minute conveyor speed). The bond strengths of the laminates were determined by a T-peel test in a T-peel setting at 2 inches per minute on 1 inch wide strips. An adhesive coat weight of 2.3 lb per ream was applied.

The PET/Foil laminate structure exhibited a bond strength after 1 hour of 0.34 lb (peel), a bond strength after 1 day at room temperature of 1.26 lb (stock tear), and a bond strength after 1 day in a water soak test of 0.60 lb (stock tear). The PET/Foil/PE laminate structure exhibited a heat seal strength after 1 day at room temperature of 17.24 lb (stock tear), a heat seal strength after 1 day at 70 degrees C. of 5.2 lb (bridge stock tear), and a heat seal strength after 1 day at 85 degrees C. of 5.1 lb (bridge stock tear).

The adhesive of this example exhibited improved instantaneous bond strength (i.e., bond strength measured after 1 hour) as compared to the adhesives of Examples 4 and 5. The adhesive also provided good moisture resistance and strong heat seal bonds at both room temperature and higher temperatures.

### Example 7

Example 1 was repeated, except that an adduct prepared by reacting a non-chlorinated polyester acrylate containing residual carboxylic acid groups with C12-C14 aliphatic epoxy was utilized in place of the epoxy-modified polyester acrylate employed in Example 1.

The following results were obtained:

Bond Strength (lb)

| Laminate Structure | 1 Hour | 72 Hours |
|---|---|---|
| 48 ga PET/FOIL | 0.03 (peel) | 1.41 (peel) |
| 92 ga PET/FOIL | 0.04 (peel) | 2.36 (stock tear) |

What is claimed is:

1. A dual cure adhesive comprising at least one isocyanate-functionalized polyurethane prepolymer, at least one acidic hydrogen-containing hardener, and at least one (meth)acrylate-functionalized compound selected from the group consisting of polyester (meth)acrylates containing hydroxyl functional groups, adducts of epoxy-functionalized poly(meth)acrylic resins and (meth)acrylic acids, polybutadiene (meth)acrylates, and polyoxyalkylene ether mono(meth)acrylates.

2. The adhesive of claim 1, comprising at least one polymeric polyol.

3. The adhesive of claim 1, additionally comprising at least one photoinitiator.

4. The adhesive of claim 1, comprising at least one chlorinated polyester (meth)acrylate.

5. The adhesive of claim 1, comprising at least one oxyalkylene ether mono(meth)acrylate selected from neopentylglycol propoxylate methylether monoacrylates or 2-(2-ethoxyethoxy)ethyl acrylate.

6. The adhesive of claim 1, comprising at least one adduct of an epoxy compound and a polyester (meth)acrylate bearing one or more carboxylic acid groups per molecule.

7. The adhesive of claim 1, comprising both a) at least one polyester (meth)acrylates containing hydroxyl functional groups which is an adduct of an epoxy compound and a polyester (meth)acrylate bearing one or more carboxylic acid groups per molecule and b) at least one polyoxyalkylene ether mono(meth)acrylate.

8. The adhesive of claim 1, comprising both a) at least one adduct of an epoxy-functionalized poly(meth)acrylic resin and a (meth)acrylic acid and b) at least one polyoxyalkylene ether mono(meth)acrylate.

9. The adhesive of claim 1, comprising both a) at least one polybutadiene (meth)acrylate and b) at least one polyoxyalkylene ether mono(meth)acrylate.

10. The adhesive of claim 1, comprising at least one polyester polyol.

11. The adhesive of claim 1, additionally comprising at least one auxiliary radiation-curable compound.

12. The adhesive of claim 1, comprising at least one adduct of a C8 to C22 aliphatic mono-epoxy compound and a chlorinated polyester (meth)acrylate bearing one or more carboxylic acid groups per molecule.

13. The adhesive of claim 1, comprising at least one polyoxyalkylene ether mono(meth)acrylate having the general structure: 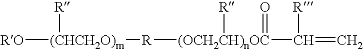
where R is —CH₂CH₂—, —CH₂CH(CH₃)—, —CH₂CH(CH₃)CH₂—, or —CH₂C(CH₃)₂CH₂—, R′ is methyl, ethyl, propyl, isopropyl, butyl, isobutyl, amyl or n-hexyl, the R″ groups are the same or different and are selected from H, CH₃, or CH₃CH₂, R′″ is H or CH₃, m is 0 to 6, n is 0 to 6, and m+n is at least 1 and not greater than 6.

14. A method of bonding a first substrate to a second substrate, said method comprising forming a layer of the adhesive of claim 1 between said first substrate and said second substrate and curing said adhesive, said curing including the step of exposing said adhesive to an amount of radiation effective to initiate reaction of said at least one (meth)acrylate-functionalized compound.

15. The method of claim 14, wherein said first substrate and said second substrate are the same or different and are independently selected from the group consisting of polymeric films and metallic foils.

16. The method of claim 14, wherein said adhesive is formed by mixing a Part A and a Part B and wherein said Part A comprises said isocyanate-functionalized polyurethane prepolymer and Part B comprises said acidic hydrogen-containing hardener.

17. The method of claim 14, wherein partial curing of the adhesive takes place before said first substrate is joined to said second substrate with the layer of adhesive placed therebetween.
